(19) United States
(12) Patent Application Publication
(10) Pub. No.: US 2024/0309891 A1
(43) Pub. Date: Sep. 19, 2024

(54) TWO-STAGE PNEUMATIC SUPPLY ARCHITECTURE FOR LIGHT-WEIGHT UNTETHERED PNEUMATIC ACTUATION SYSTEMS

(71) Applicant: COUNCIL OF SCIENTIFIC AND INDUSTRIAL RESEARCH AN INDIAN REGISTERED BODY INCORPORATED UNDER THE REGN., New Delhi (IN)

(72) Inventors: Aman ARORA, Durgapur (IN); Debadrata SARKAR, Durgapur (IN); Soumen SEN, Durgapur (IN)

(21) Appl. No.: 18/604,087

(22) Filed: Mar. 13, 2024

(30) Foreign Application Priority Data
Mar. 14, 2023 (IN) 202311017238

(51) Int. Cl. F15B 1/04

(52) U.S. Cl. CPC F15B 1/04; F15B 2201/4053

(57) ABSTRACT

A two-stage accumulator based pneumatic supply architecture (TAPSA) is provided for rapid actuation of multiple compliant pneumatic actuators simultaneously for their potential applications in wearable robotic assistive and rehabilitative devices, serving as light-weight and untethered actuation systems. The TAPSA comprises Polyethylene Terephthalate (PET) bottles serving as primary accumulators and secondary accumulators connected in series. Individual targeted levels of pneumatic pressures are achieved in actuators of the TAPSA within targeted durations of time for the rapid actuation of the actuators by the action of Pulse Width Modulation (PWM) controlled solenoid valves supplying pressurized air from the secondary accumulators which are in turn pressurized in prior to predetermined levels based on system performance model developed by a data driven approach utilized in the TAPSA. Rejuvenation of pressure in the secondary accumulators occurs through a pressure feedback based PD control scheme executed in between consecutive actuation cycles.

### CROSS-REFERENCE TO RELATED APPLICATIONS

This Non-provisional application claims priority under 35 U.S.C. § 119(a) to India patent application Ser. No. 20/231,1017238, filed on 14 Mar. 2023, the entire contents of which is hereby incorporated by reference in its entirety.

### FIELD OF INVENTION

The present invention relates to a two-stage pneumatic supply architecture finding its application in pneumatic actuation systems of rehabilitative or assistive robotic devices, particularly for enabling the pneumatic actuation systems to be light-weight and untethered.

### BACKGROUND OF INVENTION AND DESCRIPTION OF PRIOR ART

The advancement of technology has brought a transition in the type of actuators or prime-movers utilized in robotic devices. Modern robotic assistive or rehabilitative devices utilize custom built soft actuators possessing the required amounts of compliance or performance characteristics for targeted applications. The use of such soft actuators employing pressurized air as the source of energy, in other words ‘pneumatic soft actuators’ has gained much attention due to the inherent high power-to-weight ratio.

Such actuation systems are mostly in the form of wearable robotic devices. During the design of such actuation systems, emphasis is given on the design of untethered systems so that the mobility of the wearer is not restricted due to predetermined lengths of signal cables or pneumatic supply lines. Further, during the design of such actuation systems, emphasis is also given on making the actuation system to be light-weight, involving minimum amount of hardware components. Further, during the design of such actuation systems, emphasis is given on developing a simple, robust and fast control algorithm which enables rapid actuation of such soft actuators, thus making them capable of being utilized for real-world assistive applications.

Reference may be made to US patent no. U.S. Pat. No. 8,777,246B2, entitled “Compressed air supply system and control method”. A drawback in this compressed air supply system and control method is the use of a pneumatic pressure maintaining device which is often bulky and not available in custom ranges of operating pressure. Thus, the compressed air supply system involves complex hardware and also does not specifically mention the applicability to real-world applications involving rapid actuations. This makes the compressed air supply system ambiguous regarding the usage in an untethered and light-weight actuation system.

Reference may be made to US patent no. U.S. Pat. No. 1,062,5546B2, entitled “Air supply system for a work vehicle”. The pneumatic circuit in this air supply system primary applicable to be fitted to a vehicle, involves the use of an air compressor as a primary source of pressurized air, thus making the air supply system too bulky to be applicable for usage in wearable robotic devices. Further, there is no specific mention of any apparatus or technique to achieve a targeted pressure in the destination device in concern within a targeted time duration. Also, the ability of the air supply system to be miniaturized for a wearable device is not clear, thus possibly not catering to wearer comfort and a light-weight system.

Reference may be made to the work of “Taylor R. Young, Matheus S. Xavier, Yuen K. Yong and Andrew J. Fleming, A Control and Drive System for Pneumatic Soft Robots: PneuSoRD, 2021 IEEE/RSJ International Conference on Intelligent Robots and Systems (IROS), 27 September-1 October 2021, Prague, Czech Republic”. This work does not involve a two stage accumulator system, and does not employ individual accumulators for each actuator in concern. Thus, the achievement of target pressure in the multiple actuators depends solely on the performance of the control algorithms used to control the on/off or proportional valves, namely Proportional Integral Derivative (PID) control, bang-bang control, and hysteresis control. Also, the presence of a single accumulator necessarily brings about control issues in achieving targeted pressure rapidly within targeted durations of time in multiple actuators. Thus, the main drawback in this work is the control algorithm which is too complex for rapid control of soft actuators in real-world applications.

Reference may be made to the work of “Z. Situm, D. Pavkovic, B. Novakovic, Servo Pneumatic Position Control Using Fuzzy PID Gain Scheduling, Journal of Dynamic Systems, Measurement, and Control, Vol. 126, Issue 2, page no. 376-387, June-2004”. This work particularly employs a PID controller for position control of a servo pneumatic actuator. To deal with possible variations in supply pressure, a fuzzy logic based PID gain scheduling technique has been implemented. This makes the control algorithm quite complex, especially for controlling multiple such actuators from the same pressure source. There has been no specific mention about the applicability of this technique to multiple actuators being controlled simultaneously. Further, the requirement to achieve the targeted pressure within a targeted duration of time has also not been taken into consideration, thus leaving the performance solely upon the controller and system response.

Reference may be made to the work of “Sagar Joshi and Jamie Paik, Pneumatic Supply System Parameter Optimization for Soft Actuators, Soft Robotics, Vol. 8, Issue 2, page no. 152-163, June-2020”. This work discusses the use of an air compressor as well as a high pressure accumulator as the primary source of pressurized air. This system does not involve separate accumulators for pressurization of each actuator, thus not enabling the actuators to be pressurized with individual target pressures. Further, depending upon actuator inflation and deflation requirements, the hardware components of the pneumatic circuit are optimized based on the developed mathematical simulation models. This makes the process of designing a pneumatic circuit for a soft actuator based system quite arduous and time consuming. The actuation frequency targeted in this work, utilizing the pneumatic system in concern, still lacks the ability to suffice for real-world robotic assistive applications, although rehabilitative applications can be targeted with the actuation frequency and strategy discussed in this work.

Reference may be made to the work of “Maisam J. Tehrani, Pressure Control of a Pneumatic Actuator Using On/Off Solenoid Valves, Maters' Degree Project, Stockholm, Sweden, May-2008”. The pneumatic system in this work consist of a PID based control of pressure in the pneumatic actuator utilizing solenoid valves driven through an electronic control unit. A further use of non-linear control algorithm makes the control scheme too complex for a system targeted with multiple actuators. The work neither specifies its applicability to multi-actuator systems nor ensures any technique to achieve a target pressure within a targeted duration of time, thus solely relying on the control algorithm and system response. Further, applicable range of hardware components have not been discussed, thus making its miniaturization, untethered, and light-weight form ambiguous.

Thus However, most of the aforesaid documents have implemented pressure sensor feedback based control algorithms, namely PID, fuzzy logic based gain scheduling, bang-bang control, etc., for the pressurization of the pneumatic device or actuator from an accumulator. These control algorithms although perform well in terms of achieving the desired pressure in the actuators, they are quite complex to be implemented for fast-actuating systems which are of utmost importance in wearable assistive robots targeting real-world applications and tasks. Due to the complexities, often these algorithms require a sufficient number of control iterations to reach up to their desired reference signals, thus consuming way too much time than expendable in real-world applications.

Further, most of the aforesaid documents have not clearly discussed about the applicability of the mentioned pneumatic circuits and supply techniques for multiple pneumatic actuators requiring different levels of desired pressurizations, operated simultaneously. The use of single accumulator, as observed in most of the aforesaid documents, becomes difficult in supplying pressurized air to multiple actuators requiring different desired pressures due to the continuously changing supply pressure of the accumulator. Thus, often, the gain scheduling of feedback based controllers becomes quite complex for designing systems to operate with such variations in supply pressure.

Further, most of the aforesaid documents have not specifically mentioned about the hardware components applicable for implementing the pneumatic circuit design, supply architecture and control algorithm. Thus, most of the pneumatic architecture and control techniques that are typically known remain ambiguous in terms of their implementation at a miniaturized level, whereby it can be light-weight as well as untethered for possible applications in wearable assistive and rehabilitative robots.

Thus, there is a need for a pneumatic supply architecture for pneumatic actuation systems to enable the pneumatic actuation systems to be light-weight and untethered.

### OBJECTS OF THE INVENTION

The main object of the present invention is to design a pneumatic supply architecture for a fast-acting multi-actuator system with no feedback control between the actuators and the immediate (secondary) pneumatic accumulator.

Another object of the present invention is to design a two-stage accumulator-based system to pressurize the actuator from a secondary accumulator using simple Pulse Width Modulation (PWM) based solenoid valve control.

Still another object of the present invention is to design the pneumatic actuation strategy based on a data driven system performance model to fulfill the dynamic performance requirements of the actuators in concern, by ensuring the achievement of desired pressures in the individual actuators within the specified time durations.

Yet another object of the present invention is to design the system to rejuvenate the secondary accumulator to the model based pre-determined pressure from the main accumulator using feedback based Proportional Derivative (PD) control, carried out in between the consecutive actuation cycles.

Yet another object of the present invention is to develop a light weighted and economic pneumatic system using Polyethylene Terephthalate (PET) bottles as accumulators along with minimal pressure sensing hardware having simple control strategy to enable this pneumatic supply system to be implemented in untethered wearable assistive robotic devices.

### SUMMARY OF THE INVENTION

The present invention particularly relates to a two-stage pneumatic supply architecture consisting of two accumulators connected in series, where a simple Proportional Derivative (PD) based pressure feedback control is achieved in the primary reservoir. In order to make the control algorithm fast, robust, and simple, no feedback mechanism is employed during the pressurization of an actuator from the secondary accumulator, which solely takes place on the basis of a strategically designed and predetermined performance model employing solenoid valves. Thus, rapid actuation can be achieved in the actuators, making the system suitable for real-world applications. The use of Polyethylene Terephthalate (PET) bottles as accumulators has enabled the entire system to be light-weight. Thus, the present invention fulfills the supply of pressurized air for soft pneumatic actuators. Further, the present invention provides an pneumatic actuation system that is light-weight and untethered, thereby enhancing wearer's mobility and comfort.

The present invention provides a two-stage accumulator based pneumatic supply architecture (TAPSA) for light-weight untethered systems. The TAPSA comprises Polyethylene Terephthalate (PET) bottles serving as one or more primary accumulators and one or more secondary accumulators. The one or more primary accumulators and the one or more secondary accumulators are connected in series. Individual targeted levels of pneumatic pressures are achieved in actuators of the TAPSA within targeted durations of time for rapid actuation of the actuators by the action of Pulse Width Modulation (PWM) controlled solenoid valves supplying pressurized air from the one or more secondary accumulators which are in turn pressurized in prior to predetermined levels based on system performance model developed by a data driven approach utilized in the TAPSA. Rejuvenation of pressure in the one or more secondary accumulators occurs through a pressure feedback based PD control scheme executed in between consecutive actuation cycles. In an example, the pressure feedback based PD control scheme may be a simple pressure feedback based PD control scheme.

The design and development of a two-stage accumulator based pneumatic supply architecture makes possible the rapid actuation of multiple compliant pneumatic actuators simultaneously for their potential applications in wearable robotic assistive and rehabilitative devices, serving as light-weight and untethered actuation systems. Most of the typically known pneumatic architectures and control techniques implement pressure feedback based closed loop control schemes in pressurizing the actuators involving algorithms that are too complex to achieve a desired pressure rapidly with minimal control iterations. The present invention does not involve any feedback control between the actuators and the immediate accumulators that supply pressurized air to them. The present invention envisages the use of a simple data driven system performance model to achieve individual desired pressures in each actuator by solenoid valve control, ensuring it occurs within the targeted duration of time. Further, the innovative use of Polyethylene Terephthalate (PET) bottles as accumulators proves to be efficient in making the entire system economical and light-weight. A simple Proportional Derivative (PD) based control scheme rejuvenates the individual secondary accumulators up to the model based predetermined pressures from the primary reservoir, in between the consecutive actuation cycles. Thus, this pneumatic supply scheme makes possible the individual pressurization of multiple actuators simultaneously in spite of the continuous decrease in supply pressure level in primary reservoir through a simple yet reliable technique.

Thus, the present invention involves an innovative usage of two-stage pneumatic accumulators, which makes possible the supply of pressurized air of different levels to multiple actuators simultaneously in spite of a continuously decreasing supply pressure in primary reservoir.

Further, it is generally quite difficult to achieve precise control in a fast acting pneumatic system where the supply pressure in the primary reservoir (source) continuously changes due to consecutive usage. In the present invention, the implementation of a data driven system performance based model has enabled to maintain the specific pre-determined pressures in the individual secondary accumulators. This makes possible the simultaneous operation of multiple actuators, achieving the required targeted pressure in required targeted time durations with the help of solenoid valves controlled by PWM signals.

Further, the replenishment of the secondary reservoirs can be done over a greater duration of time (in between consecutive fast actuations). Thus, it can be accomplished using a simple PD control system with pressure feedback from the secondary reservoirs, thereby ensuring sufficient numbers of iterations of the control system.

The use of PET bottles as accumulators makes the entire system economic and light-weight especially for untethered wearable assistive robotic applications.

The design of a pneumatic supply architecture, according to the present invention, envisages two-stage pneumatic accumulators connected in series and a primary reservoir supplying pressurized air to multiple secondary accumulators, one for each actuator. Further, any pressure feedback based control scheme is not used in the present invention for pressurization of the actuators in concern from the immediate secondary accumulators. Rather, a data driven system performance model is utilized to maintain secondary accumulators at predetermined pressures based on the model. Further, according to the present invention, the use of PET bottles, serving as the multiple pneumatic accumulators, make the entire system economical as well as light-weight. The hardware arrangement of the present invention is totally reliable to serve as pneumatic supply systems for wearable robotic assistive devices.

These and other features, aspects, and advantages of the present subject matter will be better understood with reference to the following description. This summary is provided to introduce a selection of concepts in a simplified form. This summary is not intended to identify key features or essential features of the disclosed subject matter, nor is it intended to be used to limit the scope of the disclosed subject matter.

### BRIEF DESCRIPTION OF THE ACCOMPANYING DRAWINGS

The following drawings form a part of the present specification and are included to further illustrate aspects of the present disclosure. The disclosure may be better understood by reference to the drawings in combination with the detailed description of the specific embodiments presented herein. In the drawings, the reference numbers/letters indicate corresponding parts in the various figures.

FIG. 1 represents a two-stage accumulator based pneumatic supply architecture when a pneumatic supply system is not in an operating condition, according to an example.

FIG. 2 represents a configuration of a pneumatic supply system, according to an example.

FIG. 3 represents a configuration of a pneumatic supply system, according to another example.

FIG. 4 represents a schematic representation of a pneumatic supply system, according to an example.

FIG. 5 represents characteristic plots of a pneumatic supply system pressurizing two soft contractile actuators, according to an example.

FIG. 6 represents characteristic plots of a pneumatic supply system, according to another example.

### DETAILED DESCRIPTION OF THE INVENTION

Those skilled in the art will be aware that the present disclosure is subject to variations and modifications other than those specifically described. It is to be understood that the present disclosure includes all such variations and modifications. The disclosure also includes all such steps, features, compositions, and compounds referred to or indicated in this specification, individually or collectively, and any and all combinations of any or more of such steps or features.

For convenience, before further description of the present disclosure, certain terms employed in the specification, and examples are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of elements or steps but not the exclusion of any other element or step or group of elements or steps.

The present disclosure is not to be limited in scope by the specific embodiments described herein, which are intended for the purposes of exemplification only. Functionally equivalent products and methods are clearly within the scope of the disclosure, as described herein.

As discussed in the background, there is a need in the art to develop a pneumatic supply architecture for pneumatic actuation systems to enable the pneumatic actuation systems to be light-weight and untethered.

The present invention provides a two-stage accumulator based pneumatic supply architecture (TAPSA) for light-weight untethered systems. The TAPSA comprises Polyethylene Terephthalate (PET) bottles serving as one or more primary accumulators and one or more secondary accumulators. The one or more primary accumulators and the one or more secondary accumulators are connected in series. Individual targeted levels of pneumatic pressures are achieved in actuators of the TAPSA within targeted durations of time for rapid actuation of the actuators by the action of Pulse Width Modulation (PWM) controlled solenoid valves supplying pressurized air from the one or more secondary accumulators which are in turn pressurized in prior to predetermined levels based on system performance model developed by a data driven approach utilized in the TAPSA. Rejuvenation of pressure in the one or more secondary accumulators occurs through a pressure feedback based PD control scheme executed in between consecutive actuation cycles. In an example, the pressure feedback based PD control scheme may be a simple pressure feedback based PD control scheme.

In an embodiment of the present invention, a single actuator system has been implemented where a pneumatic actuator being operated is any axial type contractile or extensile actuator or any bending actuator.

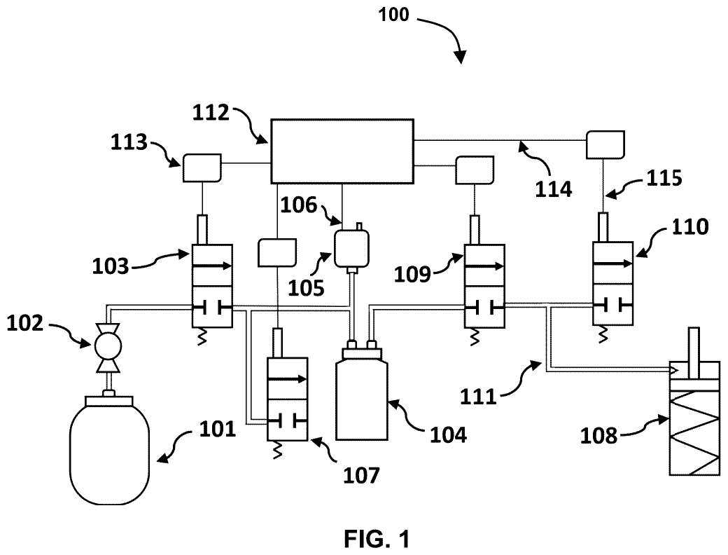

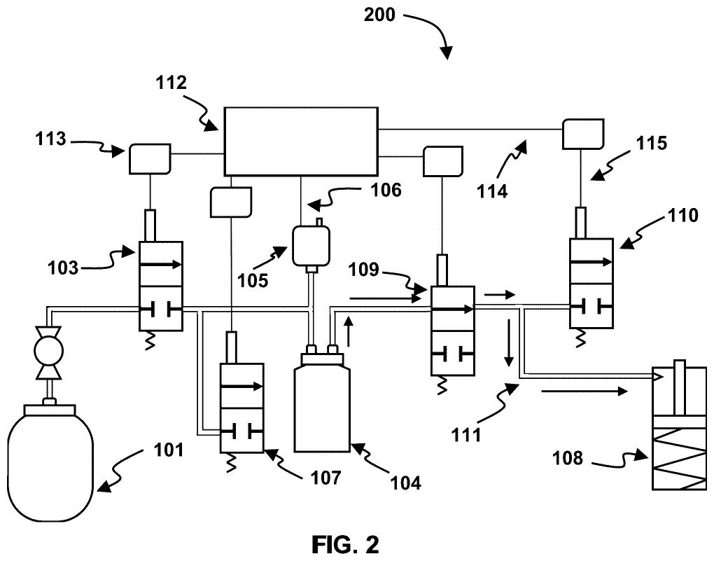

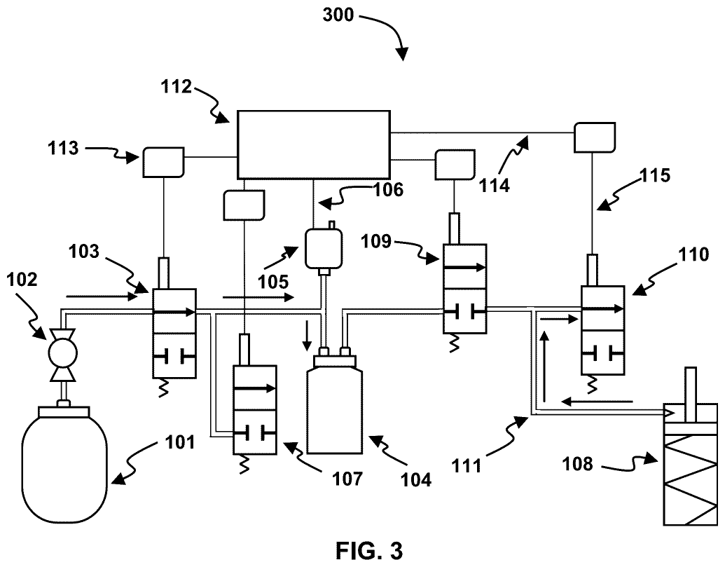

Elements in FIG. 1, FIG. 2, and FIG. 3 include a primary reservoir 101, a ball valve 102, solenoid pneumatic valves 103, 107, 109, and 110, a secondary accumulator 104, a pneumatic pressure sensor 105, a pressure feedback signal line 106, a single acting pneumatic cylinder 108, a pneumatic tubing 111, a microcontroller 112, a solenoid driver circuit 113, a control signal wires 114, and driving signal wires 115.

FIG. 1 illustrates a two-stage accumulator based pneumatic supply architecture (TAPSA) 100 when a pneumatic supply system is not in an operating condition, according to an example. In FIG. 1, for simplicity the pneumatic actuator is represented as the single acting pneumatic cylinder 108. The single acting pneumatic cylinder 108 has been alternatively referred to as the actuator 108. A pneumatic supply system in FIG. 1 has two 2/2 solenoid pneumatic valves 109 and 110 acting as an inlet valve 109 for pressurized air from the secondary accumulator 104 and exhaust valve 110 for passage of the air from the actuator 108 to the atmosphere. The secondary accumulator 104 is connected to the primary reservoir 101 through another 2/2 solenoid pneumatic valve 103 for inlet and another 2/2 solenoid valve 107 acts as the exhaust for the secondary accumulator 104. The primary reservoir 101 has a ball valve 102 fitted to its opening to facilitate the removal and replacement of the primary reservoir 101 with a new recharged accumulator. The pneumatic pressure level in the secondary accumulator 104 is monitored by the pneumatic pressure sensor 105 providing feedback to the microcontroller 112 through the pressure feedback signal line 106. The pressure feedback signal line 106 has been alternatively referred to as the feedback line 106. All the pneumatic components in FIG. 1 are connected using appropriate pneumatic tubing 111. The microcontroller 112 operates the solenoid valves 103, 107, 109, and 110 through the solenoid driver circuit 113. In an example, multiple solenoid driver circuits 113 may be employed for operating the solenoid valves 103, 107, 109, and 110. Each solenoid driver circuit 113 may take input of a control signal from the microcontroller 112 through the control signal wires 114 and provides a driving voltage as output through the driving signal wires 115. FIG. 1 depicts a configuration of the pneumatic supply system when the pneumatic supply system is not in the operating condition. The source of pressurized air in the entire architecture is the primary reservoir 101, which is pressurized upto a level high enough to sustain the required number of actuation cycles while fulfilling the pressure requirement in the actuator based upon a reasonable pre-calculation using the pressure-volume data of all actuators, accumulators, and tubings. The ball valve 102 fitted to the outlet of the primary reservoir 101 makes possible the replacement of the primary reservoir 101, when the pressure level in primary reservoir 101 ceases to provide further actuation cycles. In an example, the application targeted for the TAPSA 100 may be fast acting actuators where the actuator needs to be pressurized within much less time duration, but there remains sufficient duration of time between such consecutive actuations. The TAPSA 100 utilizes this time between consecutive actuations to recharge the secondary accumulator 104 upto a predetermined pressure level. This is done by using a simple PD control system based upon the pressure feedback of the secondary accumulator 104 from the pressure sensor 105. The time duration between the consecutive actuations allows sufficient numbers of iterations of the control by the microcontroller 112, driving the solenoid valves 103 and 107 through electronic driver circuits like as in 113.

FIG. 2 depicts a configuration 200 of a pneumatic supply system, according to an example. In the configuration 200 depicted in FIG. 2, the secondary accumulator 104 is being recharged, while the existing air in the pneumatic actuator 108 is being exhausted to the atmosphere by the solenoid valve 110 after the actuation is complete. The depicted arrows indicate the directions of air flow in the configuration 200 of the pneumatic supply system for better understanding.

FIG. 3 depicts a configuration 300 of a pneumatic supply system, according to another example. In the configuration 200 depicted in FIG. 2, the pneumatic actuator 108 is being supplied with pressurized air from the secondary accumulator 104 through the solenoid valve 109 driven by the microcontroller 112 through the solenoid driver circuit 113. The rejuvenation of predetermined pressure in the secondary accumulator 104 from the primary reservoir 101, as discussed earlier, also takes place during this time. The depicted arrows indicate the directions of air flow in the present system configuration for better understanding. For fast acting pneumatic supply systems, firstly, it becomes very difficult to achieve the required pressure in the actuator 108 within the required time duration using a feedback based control system due to the lack of sufficient number of control iterations. This issue further becomes complex when the pressure in the source of pressurized air, i.e., the primary reservoir 101, keeps on decreasing due to repeated actuations, when multiple actuators 108 are to be supplied with air at different levels of pressurizations. The second issue is simplified by the present invention by using a two stage accumulator system where although the pressure in the primary reservoir 101 keeps on decreasing due to repeated actuations, the air is supplied to the actuator 108 from a secondary accumulator 104 (one secondary accumulator for each actuator) recharged to a predetermined pressure prior to actuation. The first issue is avoided by the present invention by using the technique of utilizing predetermined pressure levels in the secondary accumulator 104. In an example, these predetermined levels of pneumatic pressure can be estimated based upon at least one parameter of: (i) the volume of secondary accumulator 104, (ii) volumes of actuator 108 prior to and after actuation, (iii) the targeted level of pressure in the actuator 108, (iv) the targeted time within which the pressure level is to be acquired, and (v) the external operating conditions to which the actuator 108 is subjected. The pneumatic supply architecture in the present invention takes care of the above mentioned hardware component features and efficiently utilizes a system performance model built by a data driven approach. In an example, the above mentioned parameters may be provided as input to the system performance model, allowing the system performance model to effectively determine at least one of the level of pressurization required in the secondary accumulator 104, and the required PWM profile or duty cycle of a control signal of the solenoid valves 109 and 110. The present invention thus considers all possible changes in the above mentioned hardware features, but for simplicity considers a given layout and length of pneumatic tubing 111 connecting a given set of the solenoid valves 103, 107, 109, and 110. The use of predetermined levels of pressurization of the secondary accumulator 104 as well as the control of the solenoid valves 109 and 110 through predetermined PWM signals makes possible the pressurization of the actuator 108 upto the required level within the required time, thus enabling such pneumatic supply systems to be utilized for wearable untethered assistive robotic applications.

In an example, the targeted actuator 108 to be pressurized in concern can be a conventional pneumatic actuator or a soft and compliant pneumatic actuator of axial extensile or contractile type. It can also be in the form of bending type actuators. Accordingly, the external operating conditions of the actuators to be taken into consideration while constructing the data driven system model can be axial, radial or other types of loads and external forces.

In an example, the two-stage accumulator system can be expanded for multiple actuators requiring different levels of actuation pressures. Thus, it would require individual secondary accumulators 104 for each such actuator, whereby each such secondary accumulator would be connected to the primary reservoir 101 in series.

In an example, the solenoid valves 103, 107, 109, 110 used can be of proportional type instead of being simply on/off type solenoid valves.

In an example, the range of operating conditions for the pneumatic supply system in concern may be:
1. Maximum level at which the PET bottle based primary reservoir or secondary reservoir can be pressurized is 800 kPa.
2. The minimum ratio of secondary accumulator and actuator volume is 1.2:1.
3. The minimum time duration for achieving the target pressure in actuator is 100 ms.
4. The minimum duty cycle of the solenoid valve control signal is 50%.
5. The minimum duration between consecutive actuation cycles is 500 ms.

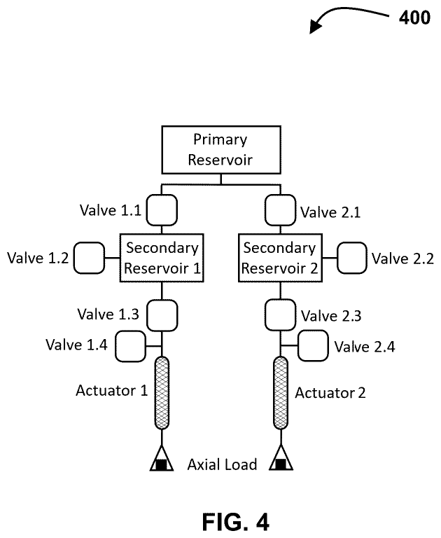

FIG. 4 illustrates a schematic representation of a pneumatic supply system 400, according to an example. The schematic representation of the pneumatic supply system 400 is given by way of illustration only and therefore should not be construed to limit the scope of the present invention. In order to understand the wide range of conditions that the claimed pneumatic supply system can be operated in, an example of the claimed product has been taken into consideration as shown in FIG. 4. The system performance and characteristic results of the pneumatic supply system 400 being operated are also discussed along with.

The basic components of the pneumatic supply system 400 developed and depicted in the schematic representation as an example are listed below. For simplicity, the pressure feedback, the microcontroller, the solenoid drivers, and the signal lines have not been represented in the schematic representation.
1. Two axial contractile type soft pneumatic actuators: actuator 1 and actuator 2. These actuators being made of elastomeric materials, due to their inherent construction, exhibit axial contraction when pressurized. With the withdrawal of air pressure, the actuators regain back their lengths. The basic characteristics of such actuators are:
   a. Unactuated length: 200 mm
   b. Maximum contraction at no load and pressurized upto 200 kPa: 52 mm
   c. Approximate internal volume of the actuator in unactuated state: 10.7 cc
   d. Approximate internal volume of the actuator when actuated at 200 kPa under no axial load: 60.6 cc
2. Axial loads have been suspended from the lower ends of each actuator.
3. A PET bottle of approximately 2090 cc serving as the primary reservoir (reservoir).
4. Two PET bottles each of approximately 530 cc serving as the secondary accumulators (secondary reservoir 1 and secondary reservoir 2).
5. Valves 1.1, 1.2 and 2.1, 2.2 for rejuvenation of the secondary reservoirs 1 and 2 respectively. Each such valve is a single valve with individual features:
   a. Orifice size: 0.76 mm
   b. Maximum flow rate of 22.5 slpm at 1034 kPa
6. Valves 1.3 and 2.3 to serve as inlet valves for pressurization of actuator 1 and 2 respectively. Each such valve is a 3-valve group connected in parallel with individual features:
   a. Orifice size: 0.51 mm
   b. Maximum flow rate of 11 slpm at 690 kPa
7. Valves 1.4 and 2.4 to serve as exhaust valves for actuator 1 and 2 respectively. Each such valve is a 2-valve group connected in parallel with individual features:
   a. Orifice size: 0.76 mm
   b. Maximum flow rate of 22.5 slpm at 1034 kPa

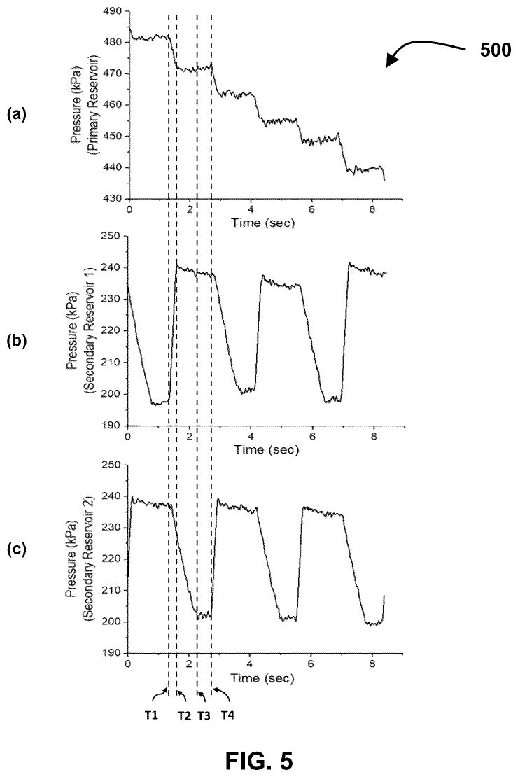

FIG. 5 represents characteristic plots 500 of the pneumatic supply system pressurizing two soft contractile actuators, according to the example given above. FIG. 5(a) depicts the instantaneous pneumatic pressure in the primary reservoir which can be seen to having been pressurized upto approximately 485 kPa initially. FIG. 5(b) and FIG. 5(c) representing the instantaneous pneumatic pressures in the secondary reservoir 1 and 2, respectively, can be observed to be having a decrease as well as increase in its pressure. The decrease in the pressure of secondary reservoirs occurs when they supply pressurized air to their respective actuators. The pressures reach back to their original levels when they get rejuvenated from the primary reservoir.

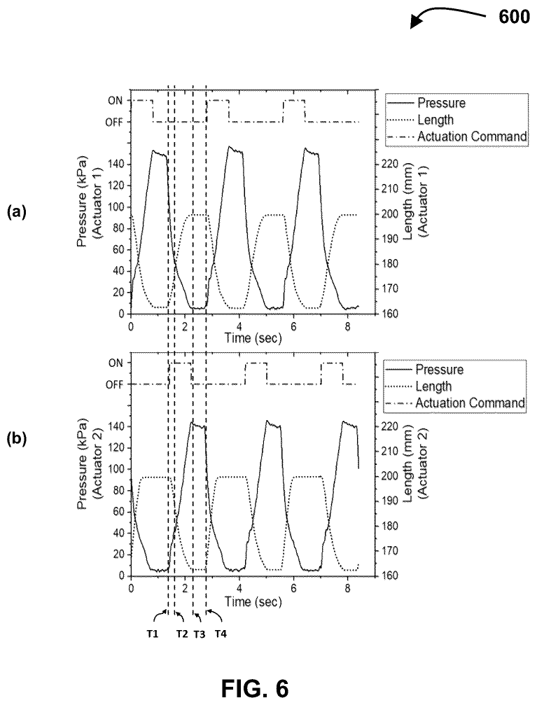

FIG. 6 represents characteristic plots 600 of the pneumatic supply system, according to the example given above. FIG. 6(a) and FIG. 6(b) depict the variations of pneumatic pressure, axial length, and control signal of the supply and exhaust valves for the actuator 1 and actuator 2, respectively. The corresponding phenomena in the actuator 1 and 2 have been depicted through FIG. 6(a) and FIG. 6(b) respectively. In each such actuator, due to the increase in pressure an axial contraction is exhibited thereby causing a reduction in actuator length. The PWM control of the inlet solenoid valves 1.3 and 2.3 as represented in FIG. 6(a) and FIG. 6(b), respectively, cause the inflow of pressurized air to actuator 1 and 2. Further when the actuation is complete, these valves cease to operate and the exhaust valves 1.4 and 2.4 become active, thereby causing a decrease in pressures in the actuators as well as increase in axial length from the contracted configuration.

In this example, the cyclic actuation processes begin with the primary reservoir being pressurized to a sufficiently high pressure of 485 kPa. Each actuator being subjected to axial load of 35 N has been attempted to be pressurized upto 150 kPa in a time duration of 800 ms, thus bringing about a contraction of 32 mm in each actuator. Each actuator is maintained at its contracted state for a time duration of 500 ms. After each actuation, while the air from the actuator gets exhausted, the corresponding secondary accumulators gets recharged upto a pressure of 242 kPa. The two actuators have been actuated in an alternate fashion as observed, in order to show the applicability of the system for assistive robotic application targeting regular human activities, e.g. the alternate movement of each leg during walking.

To explain this cyclic process of pressurization and depressurization of actuators in alternate fashion and to observe the corresponding variations in the system parameters, reference has been made to a few time instants in FIG. 5 and FIG. 6, namely t1, t2, t3 and t4.

As in FIG. 5(a), at time instant t1, the pressure in primary reservoir drops until time instant t2. This is because, during this time duration between t1 and t2, the secondary reservoir gets recharged as depicted by the rise in pressure during the corresponding time duration in FIG. 5(b). As seen in FIG. 6(a), the actuator 1 begins the exhaust of the existing air in it into atmosphere from t1. Thus, it can be observed that although this exhaust continues till time instant t3, the PD control for rejuvenating the secondary reservoir 1 from the primary reservoir proves to be a simple yet fast and effective method in terms of recharging the secondary reservoir and making it ready for the next actuation cycle of actuator 1. As mentioned earlier, since the two actuators are operated in an alternate fashion here, while actuator 1 is in exhaust configuration retaining back its length, the actuator 2 begins its contraction due to pressurization at the same time instant t1. As seen in FIG. 6(b), the corresponding solenoid valves for actuator 2 being in on state, pressure in the actuator starts rising until time instant t3. The corresponding decrease in pneumatic pressure in secondary reservoir 2, due to supply of pressurized air to actuator 2 can be observed during time duration between time instants t1 and t3. During the time duration between time instants t3 and t4, the actuator 2 maintains its contracted state as evident from the plot of its length in FIG. 6(b). At time instant t4, while actuator 2 begins its exhaust, the secondary reservoir 2 begins its rejuvenation, and actuator 1 begins its contraction. Thus, it can also be observed that the pressure in the primary reservoir keeps decreasing for every rejuvenation of any secondary reservoir.

As discussed earlier, in this example, the pressures upto which the secondary reservoirs are rejuvenated are predetermined on the basis of a system performance model developed through a data driven approach. For simplicity, some probable input features of this type of model as discussed earlier, have been considered as given features for the existing pneumatic supply system in this example. Thus, the volume of secondary reservoir and the volumes of actuator prior to and after actuation have been considered as given features for the system. Thus, (i) the targeted level of pressure in the actuator, (ii) the targeted time within which the pressure level is to be acquired, and (iii) the external operating conditions to which the actuator is subjected; here the axial load in concern suspended from the lower end of actuator, act as input features for the model. In addition to the given features, the PWM control scheme has been determined to be of signal width 100 ms and duty cycle of 90% as appropriate features to be considered for the given system. While the signal width has been determined in accordance with the maximum solenoid valve switching frequency, i.e., 50 Hz, the 90% duty cycle ensures achievement of pressure in the actuator with minimal level of pressurization of the secondary accumulators. Thus, this approach ensures minimum consumption of the driving fluid. So, the pneumatic pressure level to be maintained at the secondary accumulator acts as the sole output feature for this model.

For building this model, a full factorial based experiment with the developed pneumatic supply system in concern has been performed, the different levels of features being:
1. Pressure in secondary reservoir (in kPa): 100, 150, 200, 250, 300, 350, 400, 450, 500.
2. Time duration for achieving the target pressure in actuator (in ms): 100, 200, 300, 400, 500, 600, 700, 800, 900, 1000.
3. Axial loads (in N): 0, 25, 50, 75, 100, 125, 150.

An Artificial Neural Network (ANN) has been found to be suitable for constructing the system performance model from the experimental data. A two hidden layer network with 40 neurons in the first as well as second hidden layer along with ReLU activation functions in both the layers has been found to be appropriate after hyperparameter tuning. With a learning rate of 0.01, Adam optimizer has been found to be suitable for the model. The Root Mean Square Error (RMSE) computed from the training and testing data sets split in 80:20 have been found to be 11.83 kPa and 19.15 kPa respectively, the corresponding model of which has been evaluated satisfactorily.

Some exemplary advantages of the present invention are as follows:
1. The innovative usage of two-stage pneumatic accumulators makes possible pressurized air supply of different levels to multiple actuators simultaneously inspite of a continuously decreasing supply pressure in primary reservoir.
2. It is quite difficult to achieve precise control in a fast acting pneumatic system where the supply pressure in the primary reservoir(source) continuously changes due to consecutive usage. Thus, the implementation of a data driven system performance based model has enabled to maintain the specific pre-determined pressures in the individual secondary accumulators, making possible the simultaneous operation of multiple actuators, achieving the required targeted pressure in required targeted time durations with the help of solenoid valves controlled by PWM signals.
3. The replenishment of the secondary reservoirs can be done over a greater duration of time (in between consecutive fast actuations). Thus, it can be accomplished using a simple PD control system with pressure feedback from the secondary reservoirs, thus ensuring sufficient numbers of iterations of the control system.
4. The use of PET bottles as accumulators make the entire system economic and light-weight especially for untethered wearable assistive robotic applications.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

We claim:

1. A two-stage accumulator based pneumatic supply architecture (TAPSA) for light-weight untethered systems, the TAPSA comprising Polyethylene Terephthalate (PET) bottles serving as one or more primary accumulators and one or more secondary accumulators, the one or more primary accumulator and the one or more secondary accumulator being connected in series, wherein individual targeted levels of pneumatic pressures are achieved in actuators of the TAPSA within targeted durations of time for the rapid actuation of the actuators by the action of Pulse Width Modulation (PWM) controlled solenoid valves supplying pressurized air from the one or more secondary accumulators which are in turn pressurized in prior to predetermined levels based on system performance model developed by a data driven approach utilized in the TAPSA, and wherein rejuvenation of pressure in the one or more secondary accumulators occurs through a pressure feedback based PD control scheme executed in between consecutive actuation cycles.

2. The TAPSA as claimed in claim 1, wherein a pressure feedback based control system is not present between the actuators and the one or more secondary accumulators supplying the actuators with the pressurized air.

3. The TAPSA as claimed in claim 1, wherein a secondary accumulator of the one or more secondary accumulators is pressurized to a predetermined level based on the system performance model developed through the data driven approach, wherein possible inputs of the system performance model are the volume of each of the one or more secondary accumulators, volumes of each actuator of the one or more actuators prior to and after actuation, the targeted levels of pressure in the one or more actuators, the targeted time within which the targeted level of pressure is to be acquired in each of the one or more actuators, and external operating conditions to which each of the one or more actuators is subjected, and wherein the system performance model is to determine:
a level of pressurization required in the secondary accumulator, and
a required PWM profile or duty cycle of a control signal of the solenoid valves.

4. The TAPSA as claimed in claim 1, wherein in a two stage accumulator system of the one or more primary accumulators and the one or more secondary accumulators that are connected in series, a dedicated secondary accumulator is provided for each actuator being pressurized on the basis of the system performance model based technique such that multiple actuators are accommodated in the two stage accumulator system with individual pressure and system dynamics requirements for each of the multiple actuators.

5. The TAPSA as claimed in claim 1, wherein a secondary accumulator of the one or more secondary accumulators is repressurized from a primary reservoir when the actuator associated with the secondary accumulator is in an exhaust state and in between consecutive actuations, wherein when the actuator exhausts the air present in the actuator into atmosphere, the secondary accumulator gets rejuvenated by the primary reservoir utilizing a PD control scheme based on pressure feedback from the secondary accumulator.

6. The TAPSA as claimed in claim 1, wherein a secondary accumulator of the one or more secondary accumulators is repressurized from a primary reservoir utilizing a state feedback based control schemes.

7. The TAPSA as claimed in claim 5, wherein a secondary accumulator of the one or more secondary accumulators is repressurized from a primary reservoir utilizing a state feedback based control schemes.

8. The TAPSA as claimed in claim 1, wherein the PET bottles serving as the one or more primary accumulators and the one or more secondary accumulators are utilized as pressurized air storage devices, for supplying pressurized air to soft actuators in robotic assistive and rehabilitative devices.

9. The TAPSA as claimed in claim 1, wherein the one or more primary accumulators and the one or more secondary accumulators are made from lightweight materials like carbon fiber.

10. The TAPSA as claimed in claim 8, wherein the one or more primary accumulators and the one or more secondary accumulators are made from lightweight materials like carbon fiber.
